(19) United States
(12) Patent Application Publication
(10) Pub. No.: US 2003/0200227 A1
(43) Pub. Date: Oct. 23, 2003

(54) Vehicle and driver identification system

(76) Inventor: M. Kyle Ressler, Willoughby, OH (US)

Correspondence Address: Mark E. Bandy, Esq., Fay, Sharpe, Fagan, Minnich, & McKee, LLP, Seventh Floor, 1100 Superior Avenue, Cleveland, OH, 44114-2518, US

(21) Appl. No.: 10/126,410

(22) Filed: Apr. 19, 2002

(51) Int. Cl. G06F 17/00

(52) U.S. Cl. 707/104.1

(57) ABSTRACT

A system for obtaining information concerning automobiles, their registration data, and/or primary drivers or owners, at a distance is provided. The system includes a tag, embedded within or affixed to the vehicle license plate that remains dormant until activated. The tag is activated upon receiving a signal from a transmitter/receiver and communicates an EIN (electronic identification number) back to the transmitter/receiver. After transmitting the EIN, the tag returns to its dormant state to conserve power. The transmitter/receiver sends the EIN to a requesting police officer and/or to a central computer terminal where the information is utilized, such as for accessing a database. The information in the database corresponding to the vehicle/driver can relate to numerous aspects, e.g., registration history of the vehicle, the primary driver's driving record, medical history and next of kin notification for emergency medical services, service records, rental information for rental car agencies, and/or the owner's name and address to accommodate automated billing for the use of parking lots and toll roads. The results can be transmitted from the central computer terminal back to the requesting officer. This information allows the officer to proceed safely and/or more efficiently.

### FIELD OF THE INVENTION

The present invention relates to the identification of vehicles and drivers. More particularly, the invention relates to a method and provides a system for readily accessing information regarding vehicles, drivers, and/or owners of such vehicles. The present invention is expected to find wide application in the field of law enforcement.

### BACKGROUND OF THE INVENTION

Vehicle and driver identification is routinely performed by police officers. Currently, to obtain information regarding suspect vehicles and drivers, a police officer must see or visually inspect the license plate of the vehicle in question. Following visual identification, the police officer must verbally communicate the number of the vehicle or plate information to a police dispatcher. The police dispatcher then inputs the given information into a computer and runs a search within one or more databases accessible by the police department. The results of the police dispatcher's search are then verbally communicated back to the police officer. This method is subject to error, requires the officer to be relatively close to the automobile in question, expends valuable police dispatcher time, and utilizes precious radio bandwidth and time that could otherwise be available for other communications. Further, the need for visual identification and verbal communication substantially increases the possibility that the suspect driver will be alerted to the police officer's presence, which would increase the likelihood that the suspect will attempt to flee, resulting in increased danger to the police officer and to the general public. Accordingly, there is a need for an improved system and method of identification in which vehicle and driver information may be discreetly obtained.

Another method for a police officer to obtain vehicular and driver information, is for the police officer to “pull over” the vehicle in question and directly request information from the driver concerning the driver and the vehicle. This procedure results in danger to the police officer in approaching the suspect automobile. Furthermore, after communicating information regarding the driver and vehicle to a dispatcher, an officer typically must wait for the dispatcher to enter the information regarding the suspect vehicle or driver into the police computer and essentially, wait in line as the request is processed to receive the requested data. This results in the loss of further valuable time when encountering a suspect vehicle. Therefore, there is also a need for a technique and system for quickly obtaining vehicle and driver information.

Radio frequency techniques for transmission of vehicular information have long been known in the art. Electronic tags are known that are attached to a vehicle and transmit radio frequency electromagnetic signals. Typically, these tags utilize low power transmissions to extend battery life. However, these tags are severely restricted with regard to their range and quality of signals. Systems with longer range are known which use multiple tags, located at specified distances from one another on the vehicle. However, those systems have relatively high power demands and are relatively complex and so, require special installation. Additionally, other types of identification tags are known which store sensitive information about the automobile and/or driver and continually broadcast information to an associated receiver. But, those systems are undesirable in that unauthorized persons can intercept the information that is transmitted. Even when the information is encrypted, it can often be viewed or otherwise decoded through the use of stolen and cloned receivers. Replacing the tags and receivers often enough to thwart this interception is cost prohibitive. Therefore, there is a need for a system for providing vehicle and driver identification that is relatively simple, inexpensive, and easy to install on a vehicle.

The present invention alleviates the problems and concerns noted above by providing a unique system for vehicle and driver identification that is secure and easy to use. The present invention provides a system and method for discreetly and quickly obtaining vehicle and driver information. The system is relatively simple, inexpensive, and easy to install on a vehicle.

### SUMMARY OF THE INVENTION

The present invention provides for a fast, efficient, and reliable method for receiving needed information concerning the identification of vehicles and/or drivers. Errors that are created through verbal communication and data entry are eliminated. In addition, the present invention frees up valuable dispatcher time and radio bandwidth.

One advantage of the present invention is to quickly provide available background data on individuals prior to a police officer approaching a stopped vehicle.

Another advantage of the present invention is to aid police officers in identifying potentially dangerous offenders.

Yet another advantage of the present invention is that it enables police officers to readily determine the course of action to be taken based upon the provided data.

A further advantage of the present invention is that, with respect to serious vehicular accidents, the invention provides an on-site police officer with vital medical information or restrictions of the vehicle owner or driver.

Yet another advantage of the present invention is that the invention provides relatives of identified individuals immediate notification in emergency situations.

A further advantage of the present invention is that the invention provides insurance companies with immediate notification of accident claims.

Another advantage of the present invention is that the invention facilitates insurance companies in locating stolen vehicles.

In a first aspect, the present invention provides a method for obtaining information regarding a motor vehicle. This method comprises the steps of attaching a tag to the motor vehicle, activating the tag to cause the tag to generate a transmission containing information concerning the vehicle, receiving the transmission from the activated tag, and accessing a database using the information from the transmission from the activated tag. The method further involves a step of displaying the information from the database.

In another aspect, the present invention provides an apparatus for obtaining information regarding a motor vehicle or its registration. The apparatus comprises a tag adapted for attachment to a vehicle. The tag contains selectively accessible information concerning the vehicle or its registration. The apparatus further comprises a laser gun adapted for initiating access to the information contained by the tag. And, the apparatus includes a receiving device adapted to receive the information contained by the tag.

In another aspect, the present invention provides a system for identifying motor vehicles and associated information. The system comprises a transmitting device adapted to activate the tag, a tag adapted for attachment to a motor vehicle, and a receiving device adapted to receive the information from the tag. The tag includes provisions for electronically storing the information and transmitting the information upon activation.

In yet another aspect, the present invention provides a method for obtaining information concerning a motor vehicle or its registration. This method comprises the steps of providing a tag containing a first set of data that is transmitted upon activation of the tag. The method also includes a step of providing an activation device for activating the tag. And, the method includes a step of providing a receiving device for receiving the first set of data. The method further includes the steps of attaching the tag to the motor vehicle, and activating the tag by use of the activation device to transmit the first set of data. The method also includes steps of receiving the first set of data with the receiving device, and accessing a database using the first set of data to obtain a second set of data.

In still another aspect, the present invention provides a system for remotely obtaining selected information from a vehicle. This system comprises a first transmitter adapted to transmit one of a plurality of activation signals. This system also includes a tag adapted for mounting on a vehicle in which the tag includes (i) provisions for retaining a plurality of different sets of information, (ii) a first receiver for receiving the activation signals from the first transmitter, and (iii) a second transmitter for transmitting one of the plurality of different sets of information depending upon which activation signal is received by the first receiver. The system also comprises a second receiver for receiving the set of information transmitted by the second transmitter.

In yet another aspect, the present invention provides a method for remotely obtaining selected information from a vehicle. This method comprises providing a first transmitter adapted to transmit one of a plurality of activation signals. The method also includes a step of providing a tag adapted for mounting on a vehicle in which the tag includes provisions for retaining a plurality of different sets of information, a first receiver for receiving the activation signals from the first transmitter, and a second transmitter for transmitting one of the plurality of different sets of information depending upon which activation signal is received by the first receiver. The method also includes a step of providing a second receiver for receiving the set of information transmitted by the second transmitter. The method also includes a step of transmitting one the plurality of activation signals from the first transmitter. The method includes a step of receiving the transmitted signal from the first transmitter by the first receiver. And, the method includes a step of selecting a set of information from the plurality of different sets of information based upon the signal received by the first receiver. The method also includes a step of transmitting the selected set of information by the second transmitter. And, the method includes a step of receiving the transmitted selected set of information by the second receiver.

Still further benefits and advantages of the present invention will become apparent to those skilled in the art upon a reading and understanding of the various preferred embodiments described herein.

### BRIEF DESCRIPTION OF THE DRAWINGS

FIG. 1 shows, schematically, a preferred embodiment system in accordance with the invention for identifying a vehicle;

FIG. 2 shows, schematically, another preferred embodiment system in accordance with the present invention for identifying a vehicle and obtaining information therefrom;

FIG. 3 shows, schematically, a preferred embodiment laser gun in accordance with the present invention for transmitting an activating signal to the license plate of the vehicle;

FIG. 4 shows, schematically, a top view of the laser gun depicted in FIG. 3, for transmitting an activating signal to the license plate of the vehicle;

FIG. 5 shows, schematically, a preferred embodiment license plate according to the present invention;

FIG. 6 shows, schematically, another preferred embodiment license plate according to the present invention; and

FIG. 7 shows, schematically, another preferred embodiment system of the present invention that includes an in-vehicle dashboard screen for a police vehicle.

### DETAILED DESCRIPTION OF THE PREFERRED EMBODIMENTS

The present invention provides a system for identifying a motor vehicle, registration information associated with that vehicle, and/or a primary driver. In a preferred embodiment, the system comprises an apparatus, such as a laser gun, that sends a request/activation signal to a tag, also referred to herein as a smart tag, that is affixed to the vehicle. Upon activation, the tag transmits information that is stored within the smart tag to a receiving device that is located within a monitoring vehicle, such as a police vehicle. The receiving device may include a monitor or printer for displaying the information. Alternatively, the receiving device may utilize the requested information to obtain additional information concerning the vehicle, its registration, and/or its driver.

In operation, a police officer, wishing to obtain information on a suspect passing vehicle, emits an activation/request signal from an apparatus, such as a laser gun. This request signal activates a license plate or tag that is affixed to the suspect vehicle. The request signal from the officer (such as from the police vehicle) is preferably an electromagnetic signal and most preferably of radio frequency (RF). Optical or other signal formats may be utilized. Preferably, the signal is an RF signal and is transmitted by a receiver/transmitter from the police vehicle. Upon activation by the request signal, the vehicle's license plate or smart tag transmits the vehicle's electronic identification number (EIN).

The police vehicle receives the transmission from the smart tag (containing the EIN information) by use of a receiving device. If a decision is made to request further information concerning the suspect vehicle by the police officer, the signal from the smart tag is then relayed from the police vehicle to a receiving base station such as a local police office. The transmitted EIN is then used by the base to access a police or other database to obtain the requested information. The requested information may include information on the registration history of the car, the car itself, and/or the driving record of the person registered to the suspect vehicle. In a further preferred version of the present invention, the requested information to be obtained may include such information as the identity of the primary driver of the vehicle and all family members, age, sex, medical history, doctor, preferred hospital, contact in case of emergency, and/or blood type of the registered vehicle owner. The present invention also includes systems in which the foregoing information is contained or otherwise stored by the smart tag.

As will be appreciated, the database may be maintained or operated at the city base station, or at a central station such as one operated by the state, and/or by a third party. The requested information can then be transmitted to the police vehicle and received by the receiver/transmitter for use by the police officer. If necessary, the base station may request additional information from other base stations such as those in other states or jurisdictions. Likewise, additional information can be accessed from third party databases. Moreover, it is contemplated that the information may also be requested from centralized collections or master databases such as nationwide files that may be accessed via satellite links.

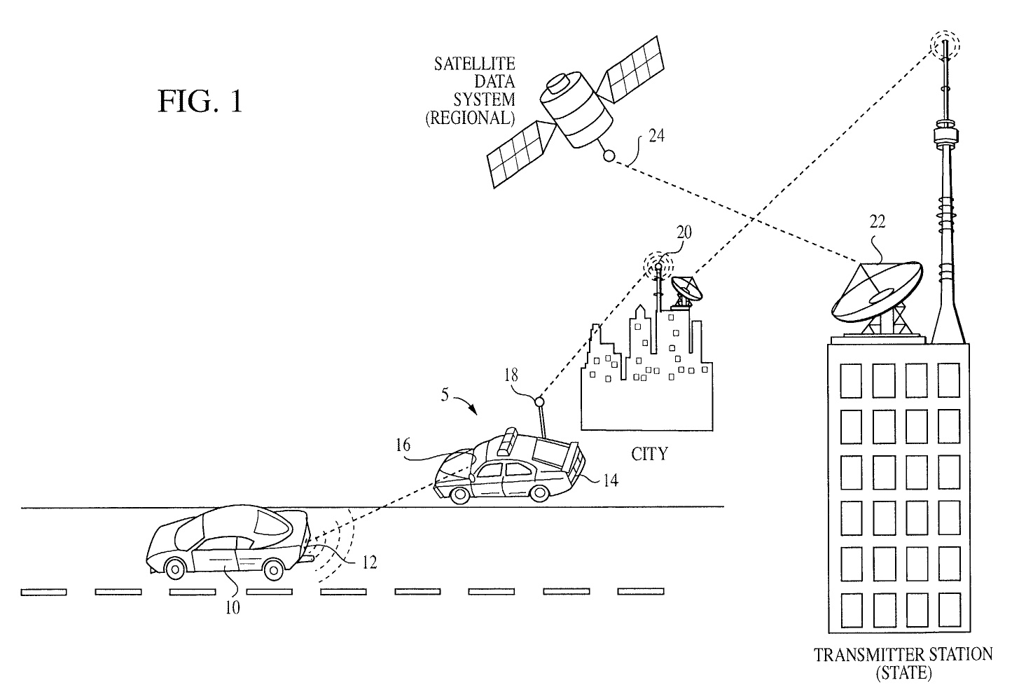

FIG. 1 schematically illustrates a most preferred embodiment of the vehicle and/or driver identification system. A police officer 5, wishing to obtain information on a suspect passing vehicle 10, emits a signal that activates a license plate or tag 12 affixed to the suspect vehicle 10. The activation signal emitted from the officer (such as from the police car 14) may be a radio frequency (RF) signal, an optical signal, or be based upon other formats as known in the art. Preferably, the signal is an RF signal and transmitted by a receiver/transmitter 16 within the police car 14. Upon activation by the police signal, the vehicle's smart tag or license plate 12 then transmits the vehicle's EIN. The police vehicle 14 receives that signal (containing the EIN information) by use of the receiver/transmitter 16 and, if a decision is made to request further information concerning vehicle 10 by the police officer, the signal is then relayed by use of a secondary receiver/transmitter 18 from the police car 14 to a receiving base station 20 such as a local police office. The present invention includes systems in which the receiver/transmitter 16 is combined with the secondary receiver/transmitter 18. The transmitted EIN is then used by the base to access a police database to obtain the requested information. The requested information may include information on the registration history of the car, the car itself, and/or the driving record of the person registered. In alternate versions of the present invention, the requested information to be obtained may include such information as the identity of the primary driver of the vehicle and all family members, age, sex, medical history, doctor, preferred hospital, contact in case of emergency, and/or blood type of the registered vehicle owner. As will be appreciated, the database may be maintained or operated at the city base station, or at a central station such as one operated by the state, and/or by a third party. The requested information is then transmitted to the police vehicle 14 and received by the secondary receiver/transmitter 18 for use by the police officer. If necessary, the base station 20 may request additional information from other base stations 22 such as those in other states or jurisdictions. Moreover, it is contemplated that information may also be requested from centralized collections or master databases such as nationwide files or databases that may be accessed via satellite links 24.

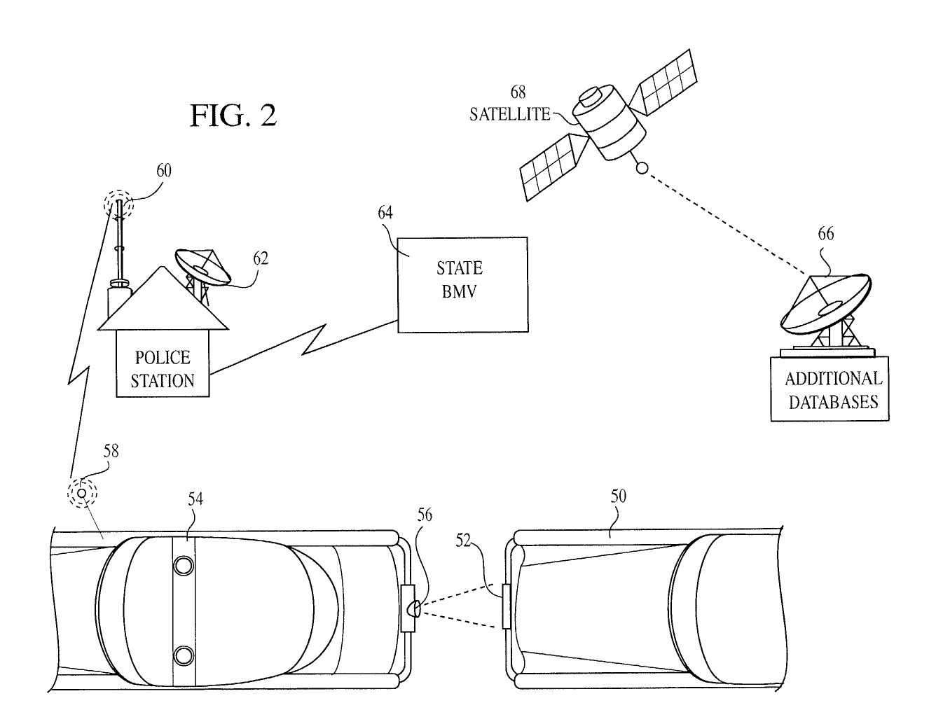

The system schematically illustrated in FIG. 2 illustrates yet another feature of the present invention. In this embodiment, one or more additional databases such as criminal databases may be accessed to provide information to a requesting officer while performing a traffic stop. In addition, FIG. 2 illustrates a preferred version in which either or both the activation signal from the requesting police vehicle (to activate the plate or tab) and/or the transmission of information by the plate or tag, is relatively narrow and focused and so unidirectional. This directional transmission feature is beneficial in that there is typically less noise or interference in the received signal. It is contemplated that either or both the receiving and/or transmitting element could be handheld or grille mounted. Other techniques for aiming or otherwise directionally selecting receiving and/or transmitting fields are contemplated.

Specifically, referring to FIG. 2, a requesting officer from a police vehicle 54 transmits an activation signal from the transmitter 56. The vehicle in question, containing a smart tag 52, is activated and returns a signal containing the EIN of the driver and/or of vehicle 50. Subsequently, if the requesting officer so desires, a request for additional information is made by transmitting a request signal 58 to a police station. A receiver 60 transmits that request and, if necessary, may contact other databases by use of one or more RF communication links 62, networked databases such as those maintained by the state's bureau of motor vehicles 64, and/or additional databases which may be accessed by one or more microwave and/or satellite links 66 and 68.

The preferred embodiment system comprises three major components. One component is a mobile transmitter such as provided in a police vehicle. In a preferred embodiment, the transmitter is located on the front of the police vehicle in order to provide a more direct transmission to the smart tag located on the suspect vehicle. The request signal preferably is based upon an RF transmission, however, other transmissions as known in the art are contemplated for use in the present invention. For instance, if the request signal is optical or light based, the transmitter may be in the form of a laser gun. The transmitter sends a request signal to the smart tag that is mounted on a suspect vehicle. Upon receiving the request signal by the police vehicle, the smart tag that is located on the suspect vehicle will be switched from its dormant state. Once activated, the smart tag transmits a signal back to the police vehicle that contains the EIN information of the suspect vehicle. Formats based upon infra-red and microwave transmission are also envisioned.

It is also contemplated that the transmitter from the police vehicle may be located on the outside of the police vehicle, for example, on the grill of the police vehicle. In this embodiment, the transmitter would be connected to the interior of the police vehicle, where the police officer could activate the transmitter in order to send an activation/request signal to a smart tag.

The second component of the preferred embodiment system is the tag that is located within or on the license plate of a suspect vehicle. This “smart tag” includes an electronic chip or other memory device that stores information regarding the vehicle and/or the individual to whom the vehicle is registered. This and/or other information is preferably encoded and/or may require an EIN or personal identification number (PIN) for its access. The smart tag can be integrated into a license plate during manufacturing or be affixed to the license plate following manufacturing, providing for simple installation on the vehicle. The smart tag conserves energy by remaining in a dormant state until the information that is stored by the tag is requested by an activation signal that is sent from a police officer or other authorized requester. The smart tag preferably utilizes a power source that is recharged by solar energy. Alternatively, or in addition, the tag may be directly solar powered. General information can be programmed and/or stored within the smart tag by a state's bureau of motor vehicles, or some other governmental office, which issues the license. Vehicle and/or driver or owner information may be partitioned or segregated according to its sensitivity. In some configurations, vehicle and/or driver or owner information is not stored within the tag. Instead, this type of information is stored in a remote database that is accessed upon receiving the EIN or PIN from the tag. Nonconfidential information can be stored directly within the tag. Information that is more sensitive, for instance information concerning the driver or owner, can be maintained in a secure database, apart from the tag, that can only be accessed upon an authorized request. Other types of information that may be stored in a remote secure database include, but are not limited to, license plate, vehicle registration, and emission test expiration information. Encryption technology may be utilized to transmit confidential information. The police vehicle receives the transmitted data by using a receiving device, which is preferably located within the police vehicle. Subsequently, if the requesting officer so desires, a request for additional information is made by transmitting a second request signal to a police station. A transmitter transmits that request and, if necessary, may contact other databases by use of one or more communication links, networked databases such as those maintained by the state's bureau of motor vehicles, and additional databases which may be accessed by one or more microwave and/or satellite links.

The third component of the preferred embodiment system is a receiving device that is located within the police vehicle. Once activated, as previously described, the smart tag transmits a signal that contains the EIN of the suspect vehicle or other information to the police vehicle that has requested such information. The receiving device captures the transmission from the smart tag. Once obtained, the data that is transmitted is read by the receiving device's central processing unit (CPU) and then displayed on a monitor, or some other display method, within the police vehicle.

The range of the preferred embodiment system, i.e. the maximum operating distance between the license plate tag and the unit(s) which transmits the activation signal and receives the response signal, is about one-half mile. This relatively long range allows a police officer to obtain valuable and necessary information about the vehicle and/or driver without the driver being aware that the information is being gathered by the police officer. The safety of the police officer and the public is greatly increased because the officer will have the ability to arrange for backup for the investigation of suspicious vehicles without first alerting the driver.

The preferred embodiment system provides a more efficient, simpler, and faster method of vehicle and/or driver identification than previously known systems. By simply pressing a button, the transmitter in the police vehicle inquires from the suspect vehicle license plate its EIN, plate number, expiration date, and an array of other information.

In a most preferred embodiment, the transmitter for the preferred system described herein, is a hand-held unit, also referred to herein as a “smart gun.” The smart gun transmits the activation/request signal from the police vehicle to activate the smart tag on the suspect vehicle. The barrel of the hand-held unit is used to direct the emission or transmission of the activation signal to the general area of the license plate of the suspect vehicle.

In a most preferred version of the smart gun, a number of information selectors or infraction buttons are provided on the smart gun. Each button represents a different infraction. In operation, a police officer wishing to obtain information regarding a passing suspect vehicle directs the smart gun toward the vehicle. Rather than use traditional methods, such as visual identification of the vehicle's license plate or pulling over the suspect, the police officer points the smart gun towards the suspect vehicle and depresses one of the corresponding infraction buttons based on the infraction that the suspect vehicle is violating. For example, if a police officer wishes to obtain information regarding a suspect vehicle that is, in the officer's opinion, violating the speed limit, the officer would point the smart gun towards the suspect vehicle and then depress the “speeding button,” or a button having some like phraseology as will be appreciated by those in the field of law enforcement. The smart gun would then transmit an activation/request signal to the smart tag, which would activate and then return the requested information to the police vehicle. It is contemplated that each button will cause the smart tag to emit or transmit information that is particular to each infraction button. Certain common information may also be sent regardless of which button is depressed.

This feature relates to another significant feature of the present invention, that of selective transmission of information depending upon which of several request signals are sent. For instance, a smart gun, as described herein, is provided that may transmit multiple activation signals depending upon which button or switch is activated by the officer. Depending upon the activation signal that is transmitted by the smart gun and then which is received by the smart tag, the tag transmits a certain set of information back to the requesting officer. As previously noted, that set of information will be relevant and specifically tailored to the particular activation signal or rather particular request sent by the officer.

Preferably, a system for remotely obtaining selected information from a vehicle is provided as follows. A first transmitter adapted to transmit one of a plurality of activation signals is provided. This first transmitter may be in the form of the previously noted smart gun. Specifically, it is contemplated that a transmitting device is provided having multiple activator or selector buttons which may be activated to selectively transmit one of a collection of activation signals. Additionally, this system includes a tag for securing to a vehicle. The tag includes provisions for retaining or otherwise storing a collection of different sets of information. The tag also includes a first receiver circuit for receiving the activation signals from the noted transmitter or smart gun, and another transmitter or transmitting circuitry for transmitting one of the different sets of information depending upon which activation signal is received by the tag receiver. The system also includes another receiver for receiving the transmitted set of information. As will be appreciated, this other receiver is preferably located within the police car and is remote from the vehicle tag assembly. It is further contemplated that this system may include another transmitter or perhaps utilize the same transmitter located in the police car for transmitting an information request signal that is directed to an external database. Depending upon which activation signal is transmitted and thus which set of information is received by the receiver, this other transmitter requests particular information from the external database. The present invention also provides related methods of remotely obtaining selected information from a vehicle by use of the smart gun or selectively operable transmitting device.

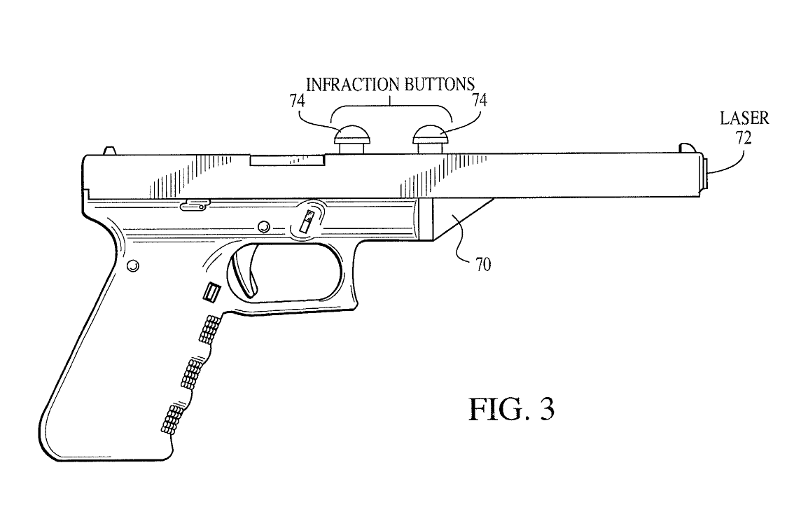

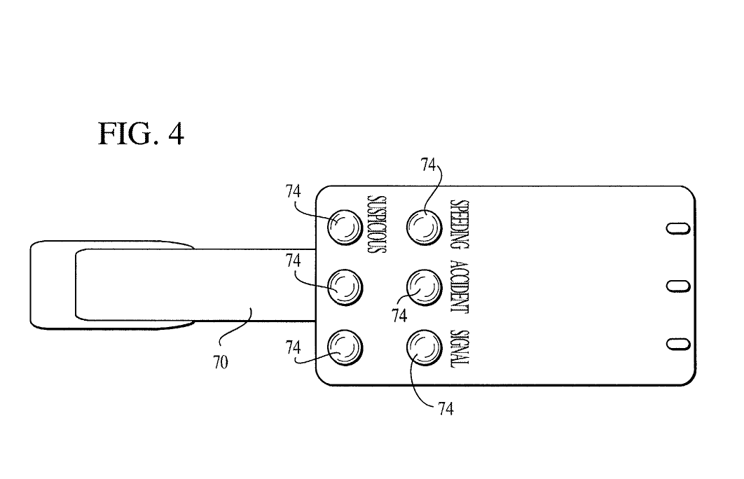

An example of a preferred smart gun for use in the preferred embodiment system is illustrated in FIGS. 3 and 4. The hand-held unit or “smart gun” 70 may be used by the officer to activate the plate or tag. The transmission of the activation signal from the smart gun may be selectively directed or aimed at a desired target, e.g. one of several vehicles. This enables a more selective triggering or activation of a single tag on a particular vehicle by the requesting officer. The gun 70 preferably provides one or more information selectors 74, as will be appreciated by those in the field of law enforcement. The smart gun 70 may also be a modified version of the currently used radar gun, so as to integrate the two functions into one piece of equipment.

The range of the smart gun is about one half of a mile. This is a relatively long range, and allows for the police officer to be a safe distance away from a suspect vehicle when identifying the vehicle and/or driver. The range of the smart gun is also based upon the frequency of the RF signal that is transmitted.

The preferred embodiment license plate or smart tag contains an antenna that is embedded within the plate to receive the activation/request signal. In the alternative, the antenna can be attached to the back of the license plate in those instances in which the smart tag is provided after the manufacture of the license plate. The antenna receives the signal from the smart gun and activates a computer chip or other circuitry that is either incorporated into the plate or is part of the tag. Once activated, the computer chip or circuitry transmits a return signal that contains the EIN of the suspect vehicle and other desired information that is programmed or otherwise retained within the computer chip. It will be appreciated that in the event a laser-based smart gun is utilized to activate the tag, a laser sensor is utilized instead of the noted antenna.

The computer chip or tag circuitry requires a power source in order to receive and transmit signals. As such, a power source is also included in the smart tag, such as one or more batteries. Preferably, a solar power source is used. It is also contemplated that an electric power source from the vehicle could be used in order to power the smart tag.

Furthermore, the preferred embodiment smart tag comprises identifying indicia such as letters or numbers affixed or otherwise imprinted upon the tag. Such indicia may be used by a state bureau or other organization to ensure that a particular smart tag is correctly associated with its designated vehicle and driver. Bar code data is contemplated. This smart tag may utilize an electronic memory or storage device such as an EPROM chip. One or more EPROM's as known in the art are envisioned for use in this system for storing the noted information.

Another feature of the preferred embodiment smart tag is a built-in electronic clock and calendar. This allows for a police officer and the suspect vehicle owner to have a record of when the smart tag was accessed in addition to any records that are kept by the police officer. The clock and calendar also contain provisions for accepting and storing one or more expiration dates associated with the particular license plate and/or vehicle.

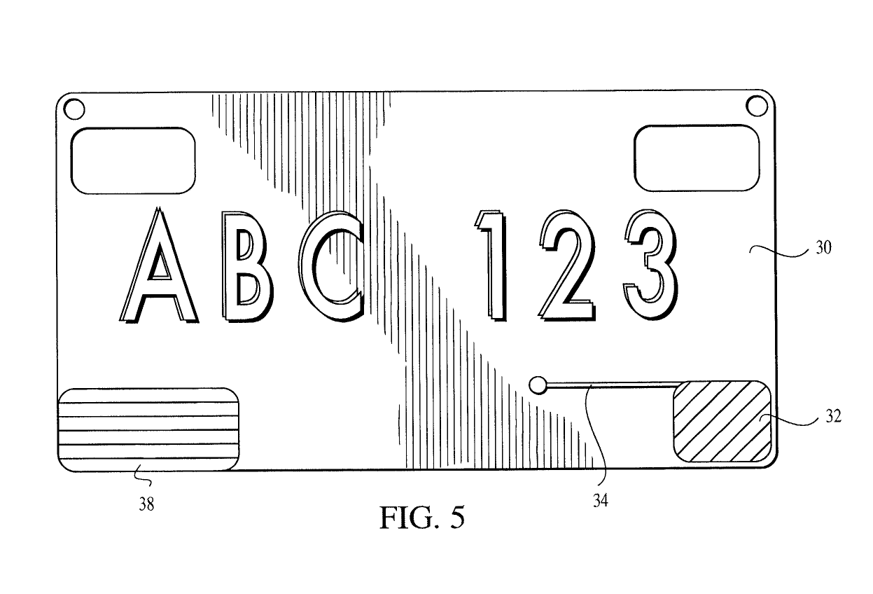

A preferred embodiment license plate is schematically shown in FIG. 5. The license plate 30 contains an integral chip 32, shown in the lower right-hand corner of the plate. Alternatively, the plate could be adapted to receive a chip which is affixed to the plate. The plate includes provisions for a battery or a solar power panel 38, and preferably an antenna 34 for RF communication to and from an activating source, e.g., the previously noted police vehicle 14.

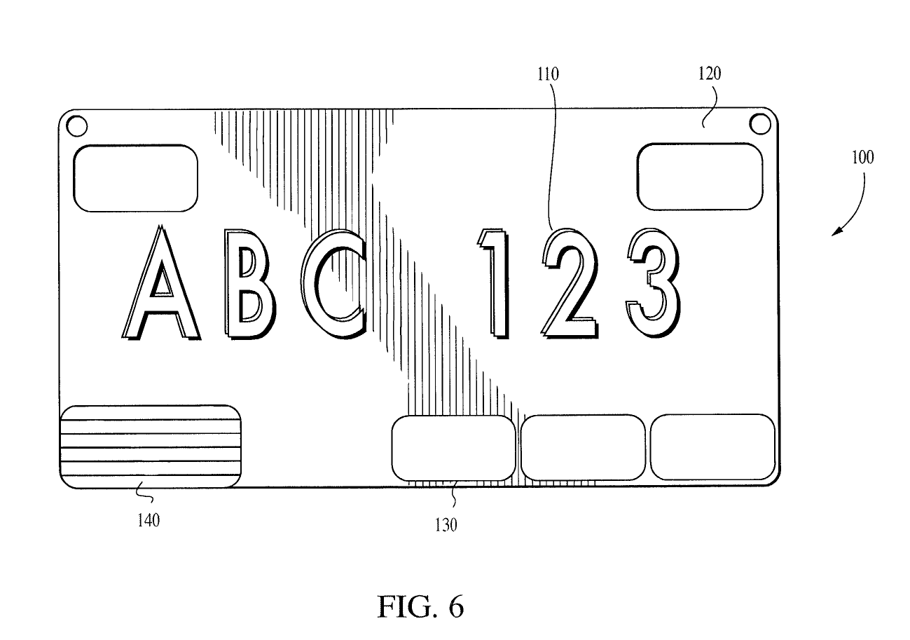

FIG. 6 illustrates another preferred embodiment license plate in accordance with the present invention. Plate 100 preferably comprises identifying indicia such as letters or numbers 110 affixed or otherwise imprinted upon a metal plate or other substrate 120, as conventionally known. Additionally attached or otherwise securely incorporated into or on the substrate 120 is a transmitter/receiver device 130 for receiving a request signal or activation signal from a police officer, and transmitting an EIN or other information back to the officer. The plate 100 also comprises a rechargeable power source, such as one or more on-board batteries. It is contemplated that two or four batteries as are typically used in personal watches or other personal electronics might be adapted for this use. Additionally, the plate 100 preferably comprises a solar cell 140 for recharging the power source. Moreover, the plate preferably comprises an onboard electronic clock and calendar with provisions for accepting and storing one or more expiration dates associated with the particular license plate and/or vehicle. One or more EPROM's as known in the art are envisioned for use in this system for storing the noted information.

As previously noted, a preferred embodiment information display system may be provided in a police car. This display system comprises a video screen or monitor as known in the art in computer systems with an electronic controller that controls and monitors the flow of information both shown on the screen and which is relayed or transmitted from the car to a receiving base station. A printer is optionally provided to provide printouts of requested or displayed information. In another variant of this display system, a microprocessor-controlled unit could be provided for accommodating on-site payment of traffic violations. Payment information could be relayed along the same transmission lines as previously noted.

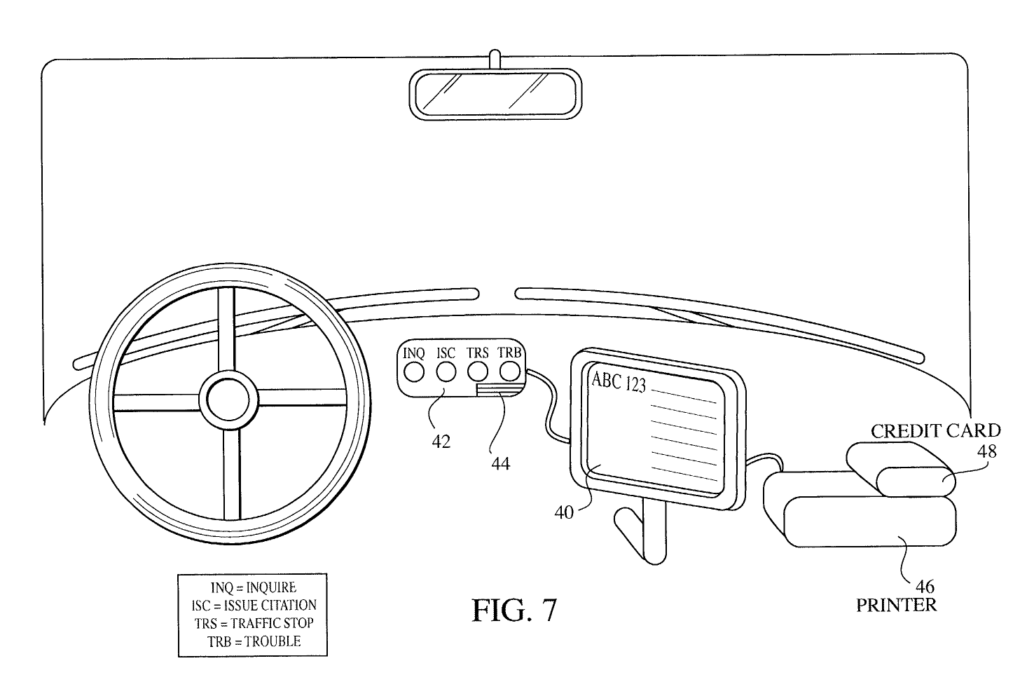

FIG. 7 represents a specific embodiment wherein a typical information display system such as may be provided in the police car is illustrated. This system generally comprises a video screen or monitor 40 as known in the art with an electronic controller 42 that controls and monitors the flow of information both shown on the screen and which is relayed or transmitted from the car to a receiving base station. The controller 44 may be combined or integrated with other components. A printer 46 is optionally provided to provide printouts of requested or displayed information. In another variant of this system, a microprocessor control unit 48 could be provided for accommodating on-the-site payment of traffic violations. Payment information could be relayed along the same transmission lines as previously noted.

According to another preferred embodiment of the present invention, a method is provided for obtaining information about a vehicle or driver using the smart tag or license plate tag as described herein. Upon activation from an authorized requester, such as a police officer, the information stored within the license plate tag is transmitted, as described herein, to a receiver that is located within the police officer's vehicle. The receiving device is preferably an integral radio transmitter and receiver. The system may further comprise a data acquisition system, such as a computer as described herein. An antenna is mounted in front of the police car and a small button and screen are located within the police vehicle. By simply pressing a button, the transmitter in the police vehicle will inquire from the suspect vehicle license plate its EIN or plate number as well as expiration date. The data acquisition unit in the police vehicle is preferably silent at all times unless an inquiry is made. If the EIN is received correctly, a sound of a chime is heard to let the police officer know that the inquiry is valid. The received data is transmitted to the police station and the requested information is sent to the police officer. In certain states or jurisdictions, this data is available on CD-ROM, and can be contained within the police car in a laptop or mobile computer. An optional printer can be used to issue citations at this point as well. An available serial interface allows direct connection to a mobile computer and eliminates the need to manually enter the license plate data in the mobile computer system. This eliminates the possibility of human errors in entering information. The receiver is preferably integrated into the police officer's mobile computer, which provides a visual readout of the information obtained. The readout is then used by the police officer in ascertaining whether to pursue the suspect vehicle.

Generally, the preferred embodiment method for identifying a vehicle and driver, comprises the steps of:

(a) emitting a radio frequency (RF) or optical activation signal that activates a license plate or tag affixed to the passing car;

(b) upon activation by the police signal, the vehicle's tag or plate then transmits an EIN (electronic identification number) and optionally, may transmit other information;

(c) the EIN from the license plate or tag affixed to the passing car is received by the police officer;

(d) if a decision to request further information on the suspect vehicle is made by the police officer, a request signal is transmitted from the police car to a receiving base station such as a local police office;

(e) the transmitted request signal containing vehicle and/or driver information is then used by the base to access a database to obtain the requested information;

(f) the requested information is then transmitted to the police car for use by the officer.

The present invention has a wide array of uses besides law enforcement. In an alternate embodiment of the present invention, the license plate tag is enabled or otherwise activated at the registrar (or state agency or bureau) and voluntarily affixed to the license plate by the vehicle owner. This is referred to herein as a “consumer friendly tag.” The consumer friendly tag would be used in conjunction with a program in which the registered owner of the vehicle would provide certain information about himself or herself at the time of license plate tag issuance. An example of the type of information that would be provided would be the primary driver of the vehicle and all family members, age, sex, medical history, doctor, preferred hospital, contact in case of emergency, and/or blood type.

A scenario in which this embodiment of the invention would be advantageous would include the scene of an automobile accident. At first, a police officer is called to the scene of the accident. The police officer would then use the smart gun to communicate with the license plate consumer friendly tag that is affixed to the vehicle or vehicles that are involved in the accident. From the communication, the consumer friendly tag PIN number is read from the microprocessor located within the license plate tag as described above. Once this number is processed by the receiver in the police vehicle, all data on the individual and the vehicle that was entered from the voluntary information given by the registered owner at the time registration is obtained through the Bureau of Motor Vehicles database. This information is then processed, and given to emergency medical/ambulatory services for a quick medical history in the case of injury in the course of the accident.

It is also envisioned that the present invention, or variants thereof, could be used in the health care field in which EMT's (emergency medical technicians) utilize a system like that described herein for accessing medical information for a driver or passenger of a vehicle. In addition, numerous uses in the private sector are contemplated in which managers or owners of vehicle fleets utilize the present invention system to store information on their vehicles. For example, such systems could be used for rental car fleets, bus and transit systems, and like applications. The present invention system could also be used in non-vehicular applications.

The foregoing description is, at present, considered to be the preferred embodiments of the present invention. However, it is contemplated that various changes and modifications apparent to those skilled in the art, may be made without departing from the present invention. Therefore, the foregoing description is intended to cover all such changes and modifications encompassed within the spirit and scope of the present invention, including all equivalent aspects.

Having thus described the preferred embodiments of the present invention, I claim:

1. A method for obtaining information concerning a motor vehicle, the method comprising:
attaching a tag to the motor vehicle;
activating the tag to cause the tag to generate a transmission containing information concerning the motor vehicle;
receiving the transmission from the activated tag;
accessing a database using the information from the transmission from the activated tag; and
displaying information from the database.

2. The method of claim 1 wherein the attaching step is performed by affixing the tag to a license plate of the motor vehicle.

3. The method of claim 1 wherein the activating step is performed by transmitting a request signal to the tag from a laser gun.

4. The method of claim 3 wherein the tag transmits information stored within it to a receiving device upon activation by the request signal sent by the laser gun.

5. The method of claim 4 wherein the information transmitted to the receiving device is relayed to a remote location where a database is accessed for further information.

6. The method of claim 5 wherein the information from the database is displayed on a monitor.

7. The method of claim 1 wherein the step of accessing the database is performed by a police officer.

8. An apparatus for obtaining information regarding a motor vehicle or its registration, the apparatus comprising:
a tag adapted for attachment to a vehicle, the tag containing selectively accessible information concerning the vehicle or its registration;
a laser gun adapted for initiating access to the information contained by the tag; and
a receiving device adapted to receive the information contained by the tag.

9. The apparatus of claim 8 wherein the tag is affixed to a license plate of a motor vehicle.

10. The apparatus of claim 8 wherein the tag is affixed to any part of a motor vehicle.

11. The apparatus of claim 8 wherein the laser gun transmits a request signal to the tag for initiating access to the information contained by the tag.

12. The request signal of claim 11 wherein the transmission is an electromagnetic transmission.

13. The request signal of claim 12 wherein the electromagnetic transmission is a radio frequency transmission.

14. The apparatus of claim 8 wherein the tag transmits the information to the receiving device upon initiation by the laser gun.

15. The apparatus of claim 8 wherein the receiving device includes a computer processing unit and a monitor for displaying the information that is received.

16. A system for identifying motor vehicles and associated information, said system comprising:
a tag adapted for attachment to a motor vehicle, the tag having provisions for electronically storing information and transmitting the information upon activation;
a transmitting device adapted to activate the tag; and
a receiving device adapted to receive information from the tag.

17. The system of claim 16 wherein the receiving device includes provisions for accessing additional information from a remote database based upon the information received from the tag.

18. A method for obtaining information concerning a motor vehicle or its registration, the method comprising:
providing a tag containing a first set of data that is transmitted upon activation of the tag;
providing an activation device for activating the tag;
providing a receiving device for receiving the first set of data;
attaching the tag to the motor vehicle;
activating the tag by use of the activation device to transmit the first set of data;
receiving the first set of data with the receiving device;
accessing a database using the first set of data to obtain a second set of data.

19. The method of claim 18 wherein the activation step is performed by the activation device transmitting an electromagnetic signal to the tag.

20. The method of claim 18 wherein the first set of data includes an electronic identification number (EIN) associated with at least one of the tag, the vehicle, and registration of the vehicle.

21. The method of claim 20 wherein the second set of information is obtained by providing the EIN.

22. A system for remotely obtaining selected information from a vehicle, the system comprising:
a first transmitter adapted to transmit one of a plurality of activation signals;
a tag adapted for mounting on a vehicle, the tag including (i) provisions for retaining a plurality of different sets of information, (ii) a first receiver for receiving the activation signals from the first transmitter, and (iii) a second transmitter for transmitting one of the plurality of different sets of information depending upon which activation signal is received by the first receiver; and
a second receiver for receiving the set of information transmitted by the second transmitter.

23. The system of claim 22 further comprising:
a third transmitter for transmitting an information request signal to an external database based upon the set of information that is received by the second receiver.

24. A method for remotely obtaining selected information from a vehicle, the method comprising:
providing a first transmitter adapted to transmit one of a plurality of activation signals;
providing a tag adapted for mounting on a vehicle, the tag including (i) provisions for retaining a plurality of different sets of information (ii) a first receiver for receiving the activation signals from the first transmitter, and (iii) a second transmitter for transmitting one of the plurality of different sets of information depending upon which activation signal is received by the first receiver;
providing a second receiver for receiving the set of information transmitted by the second transmitter;
transmitting one of the plurality of activation signals from the first transmitter;
receiving the transmitted signal from the first transmitter by the first receiver;
selecting a set of information from the plurality of different sets of information based upon the signal received by the first receiver;
transmitting the selected set of information by the second transmitter; and
receiving the transmitted selected set of information by the second receiver.
